(19) United States
(12) Patent Application Publication
(10) Pub. No.: US 2023/0307993 A1
(43) Pub. Date: Sep. 28, 2023

(54) TRAFFIC TURBINE DEVICES, SYSTEMS, AND METHODS

(71) Applicants: Michael GOREN, Schenectady, NY (US); Jeremy GOREN, Schenectady, NY (US)

(72) Inventors: Michael GOREN, Schenectady, NY (US); Jeremy GOREN, Schenectady, NY (US)

(21) Appl. No.: 18/186,085

(22) Filed: Mar. 17, 2023

Related U.S. Application Data
(60) Provisional application No. 63/479,217, filed on Jan. 10, 2023.
(60) Provisional application No. 63/322,892, filed on Mar. 23, 2022.

(51) Int. Cl. H02K 7/18; H02K 7/075; H02K 7/02

(52) U.S. Cl. CPC H02K 7/1853; H02K 7/075; H02K 7/02

(57) ABSTRACT

Power generating devices and systems that include devices, apparatus, systems and methods with a turbine assembly disposed in a recess under the road surface as the sustainable actuating mechanism include a pivoting treadle plate upon which is mounted a counterweight wherein the force of gravity raises load-bearing pivoting treadle plate that spans a recess below the roadway to a slope relative to roadways and also utilizes the movement of wheels of automobiles driving over the upper surface of the angled pivoting treadle plates or flaps with hinges to drive down the treadle plates to be substantially level and flush with the roadway as kinetic power to push down a downshaft, Pitman arm and crank to convert linear force to rotational energy to spin electric generators to generate electricity.

### CROSS REFERENCE TO RELATED APPLICATIONS

This application claims priority benefit under 35 U.S.C. § 119(e) of U.S. provisional application No. 63/479,217 filed Jan. 10, 2023, entitled Traffic Turbines and U.S. provisional application No. 63/322,892 filed Mar. 23, 2022, entitled Electric Power Generating Apparatus Actuated by Wheels of Vehicles Moving Onto a Counterweighted Pivoting Sloped Leaf, which are incorporated herein by reference in their entireties.

### FIELD OF THE INVENTION

The present disclosure relates generally to power generating devices and systems. More specifically, but not exclusively, the present disclosure relates generally to devices, apparatus, systems and methods that utilize gravity and counterweights disposed in a recess under the road surface as the sustainable actuating mechanism to raise load-bearing pivoting treadle plates or pivot plates or flaps that span a recess below the roadway to a slope relative to roadways and also utilize the movement of wheels of automobiles driving over the upper surface of the angled pivoting treadle plates or flaps with hinges to drive down the treadle pivot plate to rest on a rest member and to be substantially level and flush with the roadway as kinetic power to push down a downshaft and Pitman arm to rotate shafts and flywheels to spin electric generators to generate electricity.

### BACKGROUND OF THE INVENTION

Sustainability in the generation of electric power means increasing the number of emission-free power plants. Presently, hydro power, solar power, wind power and tidal power are used as alternatives to fossil fuels. Many ecologists maintain that hydroelectric dams and turbines often disturb fish ecosystems and put especially migratory fish at risk. Wind power adversely affects bird populations. Hydroelectric power is confined to rivers and a great deal of what is available has already been tapped. In addition, wind and solar occupy a large footprint and have opponents who claim visual pollution. Wind turbines will produce different amounts of power depending on wind speed or whether the wind is blowing at all. Wind power may vary a great deal. In some locations, in addition to the quality of the wind available, there may be social considerations that form opposition groups to using windmill generation or local bylaws that prevent building such wind turbines. Often these forms of renewables are sited a significant distance from where the electricity is needed requiring upgrading of long distance transmission lines. Pumped storage hydropower requires consuming electric power for pumping water from a lower reservoir to a reservoir at a higher elevation for storage in order to recover the gravity discharge of water from the higher reservoir to the lower reservoir through turbines when needed or when the electricity rates are higher.

Large central power stations require a large footprint and use a large amount of land and often a large number of rights of way and long-distance transmission lines. Wind power and hydroelectric plants are insufficient to meet the demands for electricity, especially when many people have the objectives both to reduce the use of fossil fuels in the generation of electricity and increase the use of electric vehicles to replace gas-fired cars. Moreover, hydroelectric dams and wind turbines are oftentimes distant from population centers and also require large powerlines to transport the electricity to where it is needed.

In view of the drawbacks of using hydro power, solar power, wind power and tidal power as alternatives to fossil fuels, alternative electric power generation means have been explored including, at least, the following U.S. Pat. Nos. 1,312,131, 1,916,873, 2,020,361, 3,885,163, 4,004,422, 4,081,224, 4,173,431, 4,211,078, 4,238,687, 5,646,615, 6,936,932, 7,530,761, 8,461,700, 8,466,570, 9,366,239, 9,410,537, and US Publication Nos.: US 2002/0089309, US 2009/0179433 and US 2011/0148121.

Drawbacks with existing vehicle energy generation technology include speed bumps that cause undesirable vibration, jarring sensations and damage to the suspension systems of vehicles that travel over them at road speeds and are therefore meant for slowing down traffic. Also, an objective of many of these systems to slow down or help with the braking of vehicles and so are designed for exit ramps or entry ramps.

For example, the drawbacks for air compressor systems include generally requiring regular maintenance, air filters and changed oil.

Many roadways, streets, highways, expressways and bridges near cities handle very large volumes of vehicular travel every day. For instance, historically, on average, the George Washington Bridge, the Tappan Zee Bridge and the Golden Gate Bridge each has been transporting over 100,000 vehicles per day over several lanes of traffic. By way of further example, according to the State of New York Traffic Data Viewer, the annual average daily traffic for the Henry Hudson Parkway is approximately 129,000. That traffic is comprised of automobiles, buses, vans, SUVs and trucks. The weights of those vehicles range from approximately 2,500 lbs. to several tons and thus are available to provide a source of kinetic energy that can power electric generators. Subways and trains are also sources for providing force for generating electricity.

Conversely, roads, streets and highways are present in population centers and oftentimes have raised or sunken powerlines running alongside them and therefore siting electric generation facilities alongside present electrical infrastructure is advantageous. Utilizing the proximity of roads to population centers and also the reliability of traffic volumes overcomes many of the drawbacks of using wind power alone.

An example of common use turbines as energy recovery devices is an expansion turbine for extracting energy from highly pressurized gas in pipelines. When a gas pipeline company needs to route high pressure gas from the main pipeline for local use, it can run high pressure gas through a turbine spinning an expander wheel which spins the shaft assembly and rotor of a generator.

Many roadways, highways and streets are traveled by thousands of vehicles per day. Many such vehicles weigh on the order of half a ton to several tons and are built for fast speed, thereby can provide a great deal of force when their wheels traveling over an angled surface such as a flap or angled plate to depress (push down) such flap/plate to the level of the road surface. Thus, moving cars generate kinetic energy due to their motion. The actuation by the heaviness and movement by vehicles such as automobiles, vans and trucks can be imparted to a treadle mechanism or an angled flap to power a generator.

Treadle-based systems for generating rotary energy are well known. For example, known treadle-based systems that include utilizing the engagement of treadle gears and drive gears are also subject to drawbacks including limitation by virtue of the small arc that such a treadle makes at its base. In such known treadle systems, spring-loaded treadles are forced down by tires of vehicles as they roll over such treadles and the treadle gears are disposed on the lower side of the treadle at the approach side of the treadle engage and drive drive-gears to rotate a shaft that turns a flywheel and a generator. Such treadle systems have additional drawbacks such as the limited amount of rotation of the treadle gears that engage the drive gear, the load upon the drive shaft, and the reliance on springs for many cycles, which may affect the durability of the system. Moreover, utilizing springs for moving the treadle from its lower horizontal position to its angled position puts a great deal of stress and wear on such springs. Retractive springs increase the resistance to arms or shafts and will need frequent maintenance.

Known power generation systems include vehicle-activated treadles disposed at an angled position relative to the surface of the roadway, which treadles can be moved by the movement of motor vehicles from a raised first position to a lowered second position. For example U.S. Pat. Nos. 8,461,700 and 8,466,570 disclose a vehicle energy harvester mounted on the surface or set in the surface of a roadway for reducing the speed of vehicles on for example exit ramps or toll plazas. In such these references, spring-loaded treadles are forced down by tires of vehicles as they roll over such treadles and the treadle gears disposed on the lower side of the treadle at the approach side of the treadle engage and drive drive-gears to rotate a shaft that turns a flywheel and a generator. Such spring-loaded treadles have drawbacks such as the amount of rotation of the treadle gears that engage the drive gear is limited, the load upon the drive shaft and the reliance on springs for many cycles may affect the durability of the system. Another disclosure of spring-loaded treadles is made in US Publication No. 2002/0089309. Also, U.S. Pat. No. 8,466,570 includes an entry ramp and exit ramp for the slope and elevation of the speed bump. U.S. Pat. No. 9,366,239 illustrates and automobile driving upon a top plate of the system before driving upon and activating the treadle. Additionally, in addition to the spring-loaded treadles, U.S. Pat. No. 8,466,571 utilizes reciprocal springs arrangement in opposition to the movement of the treadle and a reciprocal spring arrangement or assembly to move the vehicle-activated treadle away from the second position and toward the first position. Moreover, U.S. Pat. No. 9,410,537 discloses a unit with an entry ramp and exit ramp that is mounted directly on top of the existing roadway to slow vehicles, the upper surface of which system becomes an elevated surface of the roadway for vehicle wheels to drive upon. An objective of many of these systems to slow down or help with the braking of vehicles.

Typically, the efficiency of known vehicle power generation systems has been relatively low because of friction losses and systems utilizing springs and compressors require a high degree of maintenance.

Treadle-based systems that utilize the engagement of treadle gears and drive gears are subject to limitation by virtue of the small arc that such a treadle makes at its base. Moreover, utilizing springs for moving the treadle from its lower horizontal position to its angled position puts a great deal of stress and wear on such springs.

Bridges with a load-bearing deck or span that pivot about a horizontal axis that is at a right angle to the longitudinal center line of the leaf up to an open position and down to a closed position are well known. For such bascule bridges, the purpose of mounting a counterweight opposite the pivot point from the toe end of the leaf/span is to balance the span or leaf through its upward swing to allow it to be opened quickly and require little energy to operate. For such bridges, the approach end is called the “heel” and the distal outer end is called the “toe.” When the leaf pivots to the open position, the toe is actuated to an open position. Conversely, the leaf can be actuated to a horizontal closed position where the distal edge rests to be supported.

Automobiles, trucks and buses are generally configured with front bumpers that have a relatively short distance from the front edge of the bumper to the front axle and with a clearance between the undercarriage of a vehicle and road sufficient to allow the vehicle to move over bumps or uneven surfaces without scraping the bottom of the vehicle. Speed bumps designed to slow down drivers allow drivers to pass over them but can cause discomfort. Most road vehicles have at least four and a half inches or more clearance height from the road to the bottom surface of the vehicle.

Thus, while the foregoing body of known systems indicates that treadle plates—including those disposed for automobiles to run over—are well known, the provision of a simple, more effective system is not previously contemplated.

Thus, systems that overcome the above-noted drawbacks and which may be used to raise and maintain a pivoting treadle plate or pivot flap plate at a desired angle and return it to such angle after a motor vehicle has driven over it to make it unnecessary to utilize springs, motors, hydraulics or pneumatics, or to create an elevated bump in the road that is not suitable for vehicles traveling at speed on a thoroughfare are needed for generating energy using vehicle or traffic systems.

### DESCRIPTION OF RELATED ART

Methods for converting linear motion into rotational motion are well known. For instance, a rack and pinion include a circular gear engaging a linear gear; wherein driving the rack perpendicular to the rotation axis can convert linear motion into rotational motion by driving the gear into rotation. Another example is a rod or piston slider-crank mechanism that with reciprocating up and down force and motion is converted into rotary motion to propel the circular motion of a wheel about the axis of a wheel. Ball screw linear actuators are another example of the engagement of linear and rotational motion. Yet another method employs a helical thread configured on a rod, such that when force is applied to the helical thread rod, it imparts rotational energy to actuate the spinning of a mass engaged with the rod.

In oilfields, beam pump systems movement of a crank arm converts linear to rotational motion to lift fluids. Such systems employ vertically moving rods and are equipped with counterweights connected to the beam or crank arm.

There are various generators that utilize wind power, water power or tidal power that convert rotational power to turn a generator to generate electricity so that no fuel is required. Wind turbines will produce different amounts of power depending on wind speed or whether the wind is blowing at all.

Vehicles are built to ride over obstacles on the road surface such as bumps and potholes and remain stable and under control, as long as they travel posted speed limits, and the vertical obstacle height is not too large so that a lengthy loss of tire contact with the road surface. Drivers and passengers prefer even roads that do not cause too much bumpiness or vibration. Tires are manufactured to withstand bumps and potholes in the road.

The distance from the front bumper to the front axle (lowest point on front tires) may vary by the type of vehicle that is driven. In some trucks the distance may be 3 feet. Similarly, the wheelbase between the first axle and the next axle may be 20 feet in some trucks and 41 feet in others. For many cars the front bumper extends no more than three feet from the front axle.

For many cars the clearance point from the ground to the bottom of the front bumper for clearance is around 6 inches. If the ramp rises higher than the bottom of a motor vehicle, another way to provide clearance is to make the run of the load-bearing plate longer and/or adjust the speed at which the counterweight lifts the load-bearing plate back up to allow the vehicle to pass entirely over the load-bearing plate before it is raised again.

Bridges that allow ships to pass by lifting a span or leaf upwards using counterweights have been in use for many years. Such known bridges include U.S. Pat. No. 1,412,327 describes a bascule bridge that provides a counterweighted bridge in which the actuating mechanism will occupy such position and be so disposed as to be below and out of the way of the roadway and main parts of the structure.

U.S. Pat. No. 1,633,565 is another example of known bascule bridge. After a span swings upwards it is again lowered to the uniform horizontal level of the pavement of roadways. Bascule bridges are supported on an axis that is perpendicular to the longitudinal axis. That horizontal axis on which they pivot is generally located at the center of gravity of the bridge to create a balance between the weight of the leaf, span, or plate and the weight of the counterweight. Bascule bridges employ counterweights that may be located above or below the bridge deck or level of the pavement. Generally, in bascule bridges the counterweights balance the weight of the open leaf to reduce the amount of force it takes to cause an upward swing to open the span or leaf to a desired opening angle (first position). Counterweights may also be used to balance a span, leaf, or plate in a partially open position (first position). This would result, for instance, from increasing the weight of the counterweight to achieve a desired inclined leaf rather than the leaf level with the roadway. A brake or stopper may then be employed to limit the upward tilt. Typically, such counterweights are made of steel or concrete, but may be made from other materials. An advantage of employing a counterweight is to allow for rapid raising of the pivoting treadle plate or pivoting flap plate from its second position level to the roadway and for providing a minimal amount of resistance to vehicles and their momentum. Counterweights such as four-bar mechanisms are common in engineering and have been employed for many years. It is therefore desirable to provide a pivoting treadle plate/flap plate system turbine actuated by gravity to pivot to an upward angle and depressed to a substantially horizontal position by vehicles driving over it to generate electricity.

### SUMMARY OF THE INVENTION

A sustainable, zero emissions and fuel-free electric power generating device and method in accordance with one or more embodiments for the generation of electric energy from the actuation by the pull of gravity upon a counterweight to raise a pivoting treadle plate disposed on a roadway to an angle relative to the surrounding road surface and the kinetic energy of vehicles driving over such pivoting treadle plate include a traffic turbine assembly for driving a downshaft that converts linear force into rotary force to spin one or a plurality of generators to generate electricity, the turbine assembly having a substructure disposed in an excavation under a road surface on which is mounted a transverse rotating shaft on an axis perpendicular to the longitudinal axis of the pivoting treadle plate to rotationally support a load-bearing pivoting treadle plate that spans the roadway. The transverse rotating shaft on which the pivoting treadle plate is mounted is the pivot point for the pivoting treadle plate and for a counterweight mounted on the first edge of the pivoting treadle plate. The counterweight is actuated by the pull of gravity to pivot the pivoting treadle plate to be angled upwards relative to the surface of the roadway in a first position for automobiles to drive upon. In embodiments, a brake or stop can be utilized to limit the amount of upward incline of the pivoting treadle plate. The weight and movement of automobiles and trucks driving upon it depresses the pivoting treadle plate to a second position to be substantially level and flush with the roadway and supported by a rest on the distal toe side and also raises the counterweight to an upward position within the excavation beneath the road. When the vehicle passes beyond the pivoting treadle plate, gravity again pulls down the counterweight to actuate the movement of the pivoting treadle plate back to its angled first position. Coupled to and extending from the underside surface of the pivoting treadle plate proximate to its second or toe edge is at least one downshaft that in different embodiments is fixedly, tiltably or movably mounted such that when the pivoting treadle plate is depressed to its horizontal second position, the downshaft is driven downward. Each downshaft has linked at its distal lower end a coupled Pitman arm that is fixed, moveable or tiltable in different embodiments to the downshaft wherein the distal end of the downshaft engages and drives down the Pitman arm when the downshaft is extended downward and also supports the Pitman arm when the downshaft moves upward. The Pitman arm engages a crank for moving the crank in a rotational motion that converts the linear motion of the downshaft to rotational force. In embodiments, the crank may be independent or may be attached to a flywheel. Also in embodiments, the crank may engage a rotating shaft upon which a flywheel is rotationally mounted or may engage the flywheel directly. In other embodiments the rotating shaft upon which the crank is mounted may engage the rotating shaft upon which the flywheel is rotationally mounted through one or more ratchet mechanisms that enable the at least one flywheel to be a freewheel flywheel to rotate independently and faster than the one or plurality of input rotating shafts or input crank. In yet other embodiments the rotating shaft between the first flywheel and the rotating shaft upon which second freewheel flywheel is rotatably mounted engage through a ratchet mechanism to allow the second freewheel flywheel to spin independently and faster than the first flywheel. The freewheel ratchet mechanisms are mounted between adjacent driving and driven rotating shafts configured to allow the driven flywheel to spin faster so that the freewheel flywheel can continue providing speed and/or rotational torque to the adjacent driven shaft on which is rotationally mounted the freewheel flywheel. The ratchet further allows the driven rotating shaft to turn faster than the driving shaft and also keep rotating when the driving shaft has stopped. The adjacent driving shaft and driven shaft are coupled in a direction that the driving shaft provides torque to the driven shaft, yet decouples when the driven shaft rotates faster. In embodiments the directional coupling of the ratchet is in only one direction. In yet other embodiments the rotating shaft between the first flywheel and the adjacent rotating shaft upon which second freewheel flywheel is rotatably mounted engage through a ratchet mechanism to allow the second freewheel flywheel to spin independently and faster than the first flywheel. In embodiments, the ratchet mechanism is interposed between rotating shaft on which the crank is rotatably mounted and adjacent rotating shaft upon which the first flywheel is mounted. In additional embodiments, the ratchet mechanism is interposed between the adjacent rotating shaft on which the first flywheel is mounted and the adjacent rotating shaft upon which the freewheel flywheel is mounted. In embodiments the output rotating shaft between the second flywheel and generator spins the at least one linked generator directly, while in yet other embodiments the output rotating shaft is linked to a gearbox to increase or decrease the rotational the speed or force of rotation going to spin the at least one generator.

In another aspect, provided herein is an electric power generating device for the generation of electric energy from the force of gravity that moves a counterweight and the kinetic energy of vehicles driving over a pivoting plate disposed on a roadway in accordance with one or more embodiments that include a traffic turbine assembly for spinning one or more generators to generate electricity having a substructure disposed in an excavation under the road surface on which mounted on the approach side of the road and supported by such substructure is a hinge and load-bearing pivoting flap plate, wherein beneath the pivot plate is mounted a counterweight. The hinge is the pivot point for the pivoting plate. The counterweight is actuated by the pull of gravity to pivot the pivoting plate to be angled upward relative to the surface of the roadway in a first position for automobiles to drive upon. The weight and movement of automobiles and trucks driving upon it depress the pivot plate to a second position to be substantially level and flush with the roadway. When the vehicle passes beyond the pivot plate, gravity again pulls down the counterweight to actuate the movement of pivot plate to its angled first position. Coupled to and extending from the underside surface of the pivoting treadle plate proximate to its second or toe edge is at least one downshaft fixedly or movably mounted such that when the pivot plate is depressed to its horizontal second position, the downshaft is driven downward. Each downshaft has linked at its distal lower end a coupled Pitman arm wherein the distal end of the downshaft engages and drives down the Pitman arm when the downshaft is extended downward and also supports the Pitman arm when the downshaft moves upward. The Pitman arm engages a crank for moving the crank in a rotational motion that converts the linear motion of the down shaft to rotational force. In embodiments, the crank may be independent or may be attached to a flywheel. Also in embodiments, the crank may engage a rotating shaft upon which a flywheel is rotationally mounted or may engage the flywheel directly. In other embodiments the rotating shaft upon which the crank is mounted may engage the rotating shaft upon which the flywheel is rotationally mounted through one or more ratchet mechanisms that enable the at least one flywheel to be a freewheel flywheel to rotate independently and faster than the one or plurality of input rotating shafts or input crank. The freewheel ratchet mechanisms are mounted between adjacent driving and driven rotating shafts configured to allow the driven flywheel to spin faster so that the freewheel flywheel can continue providing speed and/or rotational torque to the adjacent driven shaft on which is rotationally mounted the freewheel flywheel. The ratchet further allows the driven rotating shaft to turn faster than the driving shaft and also keep rotating when the driving shaft has stopped. The driving shaft and driven shaft are coupled in a direction that the driving shaft provides torque to the driven shaft, yet decouples when the driven shaft rotates faster. In embodiments the directional coupling is in only one direction. In yet other embodiments the rotating shaft between the first flywheel and the rotating shaft upon which the second freewheel flywheel is rotatably mounted engage through a ratchet mechanism to allow the second freewheel flywheel to spin independently and faster than the first flywheel. In embodiments, the ratchet mechanism is interposed between rotating shaft on which the crank is rotatably mounted and rotating shaft upon which the first flywheel is mounted. In additional embodiments, the ratchet mechanism is interposed between the adjacent rotating shaft on which the first flywheel is mounted and the adjacent rotating shaft upon which the freewheel flywheel is mounted. In embodiments the output rotating shaft between the second flywheel and generator spins the at least one linked generator directly, while in yet other embodiments the output rotating shaft is linked to a gearbox to increase or decrease the rotational the speed or force of rotation going to spin the at least one generator.

In accordance with one or more embodiments, a method is disclosed of generating energy by moving a pivoting treadle plate disposed on a roadway actuated by the pull of gravity upon a counterweight to pivot the pivoting treadle plate to be angled upwards relative to the surface of the roadway in a first position for automobiles to drive upon, and in embodiments, method for actuation by the weight and movement of automobiles and trucks driving upon it to depress the pivoting treadle plate to a second position to be substantially level and flush with the roadway and also raises the counterweight upward within the excavation beneath the road. The traffic turbine generator comprises a substructure disposed in a recess under a road that supports a rotating shaft on which a pivoting treadle plate is mounted and serves as the pivot point for the pivoting treadle plate and for the counterweight actuated by the pull of gravity mounted on the first edge of the pivoting treadle plate to angle it upward relative to the surface of the roadway in a first position for automobiles to drive upon, wherein the speed and weight of the automobiles and trucks driving upon it depresses the treadle plate to a second position substantially level and flush with the roadway, wherein depressing the pivoting treadle plate moves a downshaft attached to and extending downward from the underside of the treadle plate downward, wherein at the lower end of the downshaft is attached a Pitman arm and driving the downshaft downward also moves the linked Pitman arm downward to engage a crank to move the crank in a rotational motion to rotate rotating shafts, one or a plurality of flywheels rotatable mounted on rotating shafts, and in embodiments utilizing on or a plurality of ratchet mechanisms and in embodiments, one or a plurality of freewheel flywheels to rotate independently and faster, and in embodiments output shafts and in embodiments a gearbox to impart rotational movement to spin a linked generator. The method comprises the steps of the pull of gravity actuating the pivoting treadle plate to pivot upwards, the speed and weight of vehicles depressing the pivoting treadle plate from the angled position to a horizontal position such that a downshaft with an attached Pitman arm is extended downward and the Pitman arm engages the crank to move in a rotational movement to rotate rotational shafts upon at least one flywheel is attached, wherein the rotation of the rotational shafts may be direct or by utilizing ratchets that power a freewheel flywheel to spin independently and/or faster than the rotational speed of the preceding rotating shaft or in embodiments, of the preceding flywheel, wherein the output shaft extending from the freewheel flywheel rotates to either directly or through a gearbox spin a linked generator.

In one aspect, provided herein is a gravity-actuated and vehicle-actuated treadle system for generating electric power, including a plate including a counterweight coupled to a first end of the plate, a pivot assembly rotatably coupled to a bottom surface of the plate, and at least one turbine assembly coupled to and extending from the bottom surface of the plate.

In another aspect, provided herein is a traffic turbine system, including a vehicle-actuated treadle system, at least one piece of road positioned at a first end of the plate, an excavation below a road surface for receiving the pivot assembly and the at least one turbine assembly, and at least one piece of road positioned at the distal second end of the plate. The vehicle-actuated treadle system including a load-bearing pivoting treadle plate including a counterweight coupled to a first end of the plate, wherein the pivoting treadle plate is actuated by vehicles driving upon the pivoting treadle plate to be depressed to a substantially horizontal position, and wherein the counterweight actuated by gravity to pivot the plate to be angled upwards, a pivot assembly rotatably coupled to a bottom surface of the plate, and at least one turbine assembly coupled to and extending from the bottom surface of the plate.

In yet another aspect, provided herein is a turbine assembly actuated for providing rotational energy to a coupled generator to generate electricity, including a pivot structure including a substructure disposed in an excavation under a road configured to support a transverse rotating shaft perpendicular to the axis of the axis of the road, affixed to the substructure and a load-bearing pivoting treadle plate pivotably mounted upon the transverse rotating shaft that comprises a pivot for the pivoting treadle plate to pivot it from a first position angled upwards relative to the surface of the road for automobiles to drive upon to a second horizontal position substantially level and flush with the surrounding road. The turbine assembly also including a counterweight mounted upon the pivoting treadle plate on the approach side of the pivot, wherein the counterweight is actuated to move downward by the pulling force of gravity to pivot the pivoting treadle plate upward relative to the surface of the road in a first position and wherein the kinetic energy of the automobiles driving upon the pivoting treadle plate depress the pivoting treadle plate to a second position level and flush with the roadway and also raises the counterweight to an upward position disposed in the excavation beneath the roadway, and wherein when the automobile passes beyond the pivoting treadle plate back onto the roadway, gravity again pulls down the counterweight to actuate the movement of the pivoting treadle plate to its angled first position and a rigid downshaft fixedly, tiltably or movably mounted on and supported by the underside of the pivoting treadle plate surface movable by the movement of the pivoting treadle plate between its first position and second position, wherein when the pivoting treadle plate is depressed by the speed and weight of automobiles from its raised first position to its lowered horizontal second position, the downshaft is driven downward. The turbine assembly further including a Pitman arm coupled to and supported by the lower end of the downshaft, wherein the Pitman arm is part of the driving system that engages a crank of a rotating structure to move the crank in a rotational motion to convert linear motion into rotational motion and at least one horizontal rotating shaft supported by one or more substructures to permit rotation from engagement of the crank rotating the at least one horizontal rotating shaft. In addition, the turbine assembly includes at least one flywheel rotatably mounted on and supported by the at least one horizontal rotating shaft to rotate to store energy, wherein the rotation of the crank rotates the shaft to rotate the flywheels and at least two adjacent rotating shafts including a driven rotating shaft and a driving rotating shaft, the driven rotating shaft and the driving rotating shaft have interposed between them a one-way and disengageable ratchet mechanism that enables the driven rotating shaft to rotate independently and faster than the driving rotating shaft, wherein the ratchet mechanism may be interposed between the crank and a first flywheel or between the driving rotational shaft on which is mounted the first flywheel and the driven rotational shaft on which is mounted a second flywheel to make the driven second flywheel into a freewheel second flywheel to continue providing speed and torque faster than the driving shaft and also keep rotating when the driving shaft is stopped to drive the rotation of a shaft to spin the generator. Finally, the turbine assembly includes an output shaft from the freewheel second flywheel that is most proximate to the generator to engage the generator to rotate the interface to spin the generator to generate electricity.

In a further aspect, provided herein is a method of generating electricity with a vehicle-actuated treadle system, including driving over a plate in the road to pivot the plate from a first position to a second position and exerting a downward motion from the plate to a drive shaft of a turbine assembly of the vehicle-actuated treadle system. The method also including converting the downward motion of the drive shaft to rotation of at least one flywheel and spinning a generator with the rotation of the at least one flywheel. Finally, the method including generating electricity from the spinning generator.

In still another aspect, provided herein is a gravity-actuated and vehicle-actuated treadle system for generating electric power, including a plate including a counterweight coupled to a first end of the plate, a hinge member coupled to a first end of the plate and a first road piece, and at least one turbine assembly coupled to and extending from the bottom surface of the plate.

The above description sets forth rather broadly the more important features of the present invention in order that a detailed description thereof that follows may be better understood. There are additional features of the invention that will be described hereinafter, and which will form the subject matter of the claims appended hereto. This Summary is not intended to limit the scope of the claimed subject matter. It is also understood that the invention is not limited in its application to the details of the construction and to the arrangement of the components set forth in the following description of illustrated in the drawings. The invention is capable of other embodiments and of being practiced and carried out in various ways. Also, it is understood that the phraseology and terminology employed herein are for the purpose of description and should not be regarded as limiting. The accompanying drawings illustrate preferred embodiments.

The features, functions and advantages that have been discussed may be achieved independently in various embodiments of the present disclosure or may be combined in yet other embodiments.

Although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above.

These, and other objects, features and advantages of this invention will become apparent from the following detailed description of the various aspects of the invention taken in conjunction with the accompanying drawings.

### BRIEF DESCRIPTION OF DRAWINGS

The accompanying drawings, which are incorporated in and constitute a part of the specification, illustrate embodiments of the invention and together with the detailed description herein, serve to explain the principles of the invention. The drawings are only for purposes of illustrating preferred embodiments and are not to be construed as limiting the invention. It is emphasized that, in accordance with the standard practice in the industry, various features are not drawn to scale. In fact, the dimensions of the various features may be arbitrarily increased or reduced for clarity of discussion. The foregoing and other objects, features and advantages of the invention are apparent from the following detailed description taken in conjunction with the accompanying drawings in which:

FIG. 1 illustrates a perspective view of a pivoting treadle plate with a counterweight mounted thereon and pivoting on a pivot point, the pivoting treadle plate angled in a slightly up position above the level of the roadway installed over a pit in a roadway with an approach side and distal forward side, in accordance with one or more aspects of the present disclosure;

FIG. 2A illustrates a side view of the pivoting treadle plate of FIG. 1 where the counterweight is pulled down by gravity and the pivoting treadle plate is mounted on the pivot point to angle the plate upwards relative to the surface of the road, in accordance with an aspect of the present disclosure;

FIG. 2B illustrates a side view of the pivoting treadle plate of FIG. 2A with the counterweight raised from the speed and weight of vehicles and a pivot point supported by a frame, while the automobile is passing over the pivoting treadle plate the pivoting treadle plate is horizontal, level and flush with the surface of the road and is resting on a rest, in accordance with an aspect of the present disclosure;

FIG. 3 illustrates a perspective view of one embodiment of a pivoting treadle plate angled slightly up above the level of the roadway installed over a pit in a roadway with an approach side and distal forward side, in accordance with an aspect of the present disclosure;

FIG. 4 is a side view of the front wheel of an automobile before engaging the pivoting treadle plate causing the pivoting treadle plate to be depressed to a horizontal position flush with the upper surface of the roadway, in accordance with an aspect of the present disclosure;

FIG. 5 is a side view of a vehicle-actuated treadle system in a first position, in accordance with an aspect of the present disclosure. The base of the substructure disposed in an excavation beneath the road supports a pinion that supports the pivoting treadle plate. The counterweight is pulled lower by the pull of gravity raising the pivoting treadle plate to an angle relative to the roadway. The downshaft mounted on and extending from the underside of the pivoting treadle plate and the Pitman arm below it are in a raised position that is not actuating movement of the crank or flywheel;

FIG. 6 is a side view of the vehicle-actuated treadle system of FIG. 5 in a second position, in accordance with an aspect of the present disclosure. The counterweight is raise, the pivoting treadle plate is horizontal flush and level with the roadway and resting on the rest. The downshaft and Pitman arm beneath it have been driven down to rotate the crank;

FIG. 7 is a partial cross-sectional, side view of the plate and turbine assembly of FIG. 5, in accordance with an aspect of the present disclosure. The downshaft is driven down by the depressing of the pivoting treadle plate downward. The Pitman arm attached at the lower distal end of the downshaft engages the crank to turn the flywheel;

FIG. 8 is cross-sectional, end view of the plate and turbine assembly of FIG. 7, in accordance with an aspect of the present disclosure. The other exemplary illustrates the downshaft, Pitman arm, crank, rotating shaft flywheel, second rotating shaft ratchet mechanism, adjacent rotating shaft with flywheel rotatingly mounted upon it and output rotating shaft to the generator;

FIG. 9 is a partial cross-sectional, side view of another plate and turbine assembly, in accordance with an aspect of the present disclosure;

FIG. 10 is a cross-sectional, end view of the plate and turbine assembly of FIG. 9, in accordance with an aspect of the present disclosure illustrates a ratchet between the rotating shaft that is rotated by the crank and the adjacent rotating shaft upon which a flywheel is rotatably mounted; and

FIG. 11 is a cross-section, side view of a hinged vehicle-actuated treadle system in a first position, in accordance with an aspect of the present disclosure.

### DETAILED DESCRIPTION FOR CARRYING OUT THE INVENTION

Generally stated, disclosed herein are pivoting treadle plates and pivoting flap systems equipped with counterweights for power generation using the kinetic energy of vehicle traffic. Further, methods for using the treadle plates and pivoting flap systems are discussed.

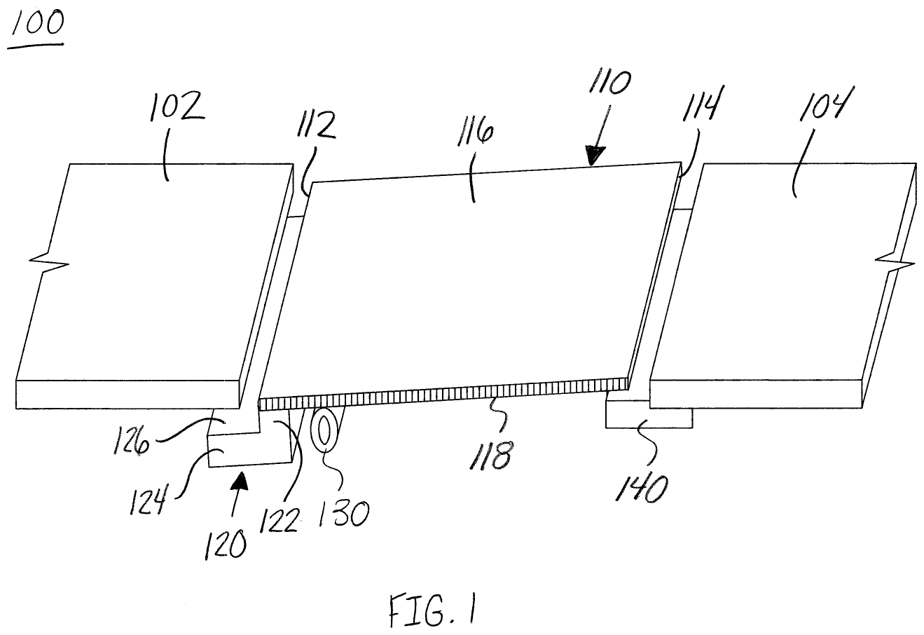

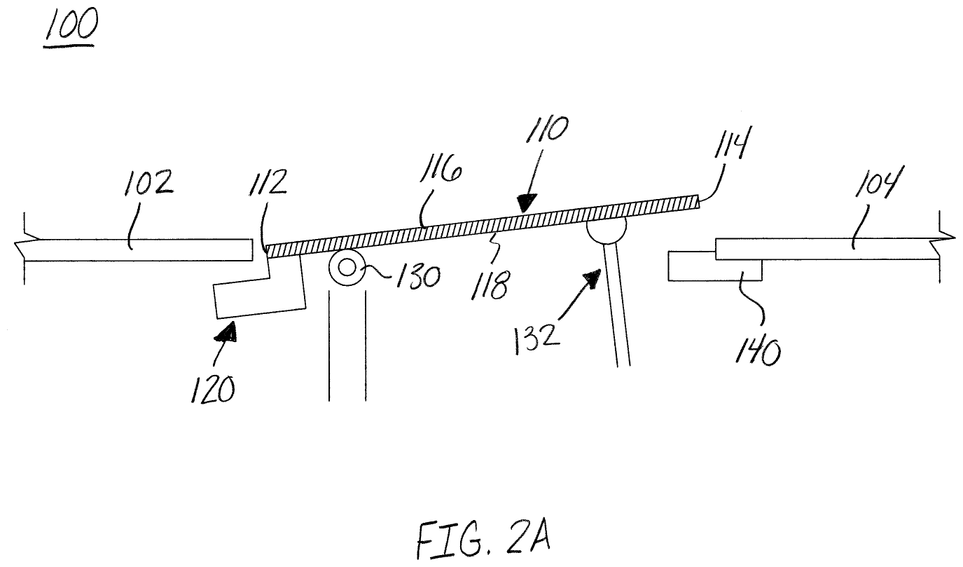

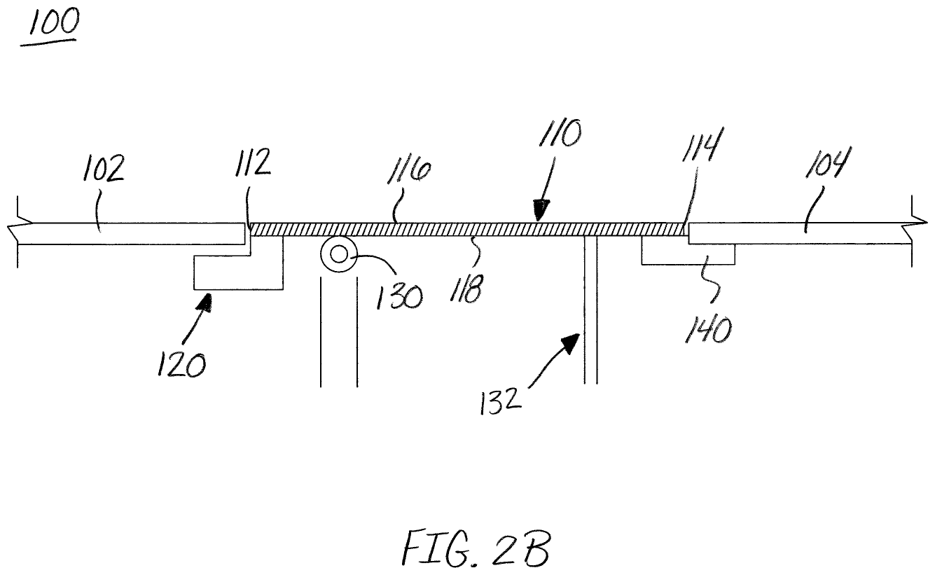

Referring to the drawings, wherein like reference numerals are used to indicate like or analogous components throughout the several views, and with particular reference to FIGS. 1-2B, there is illustrated an embodiment of a pivoting treadle system 100. The treadle system 100 includes a pivoting treadle plate or plate 110 positioned between at least two pieces of road 102, 104. The plate 110 is positioned linearly between the first piece of road 102 and the second piece of road 104. The pieces of road 102, 104 may be, for example, actual pieces of the road that have been adapted to engage with the plate 110 or additional plate pieces that engage with the actual road pieces at their exterior ends. For example, a transition plate (not shown) may be pivotally attached on one end to the roadway and on the other pivotally to the moving plate 110 to cover any gap between the approach end of the plate 110 and the adjacent roadway surface.

With continued reference to FIGS. 1-2B, the plate 110 includes a first end 112 and a second end 114. The first end 112 of the plate 110 is positioned adjacent to the first piece of road 102. The second end 114 of the plate 110 is positioned adjacent to the second piece of road 104. The first end 112 includes a counterweight 120 coupled to and extending from a bottom surface 118 of the first end 112. A top surface of the counterweight 120 is coupled to the bottom surface 118 of the plate 110. The counterweight 120 extends from the plate 110 to overhang past the plate 110 allowing for the counterweight 120 to be positioned under at least a portion of the first piece of road 102.

The counterweight 120 may include a first portion 122 and a second portion 124. The first portion 122 may be, for example, positioned perpendicular to or at a 90° angled relative to the second portion 124. The first portion 122 couples to and extends distally away from the plate 110. The second portion 124 couples to the first portion 122 and extends away from the first portion 122 in a direction opposite the second end 114 of the plate 110. The second portion 124 includes a top surface 126 that is positioned below the bottom surface of the first piece of road 102 both when the counterweight 120 is pulled down by gravity and when the plate 110 is being driven over. The counterweight 120 may be, for example, a single uniform piece extending along the entire width of the plate 110 or, alternatively, the counterweight 120 may be at least two pieces positioned along the first end 112 of the plate 110 and including at least a small space between each portion of the counterweight 120.

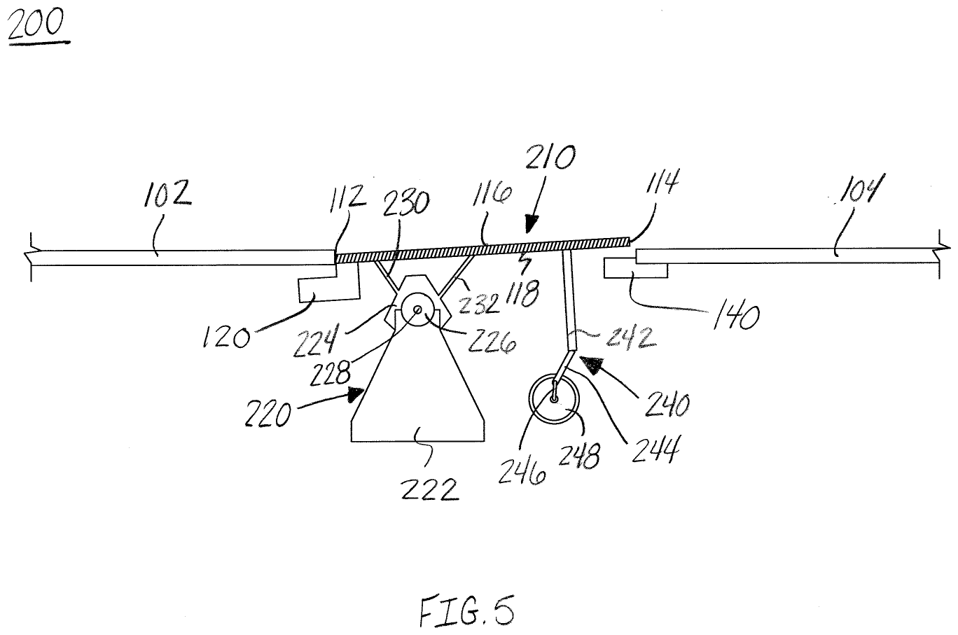

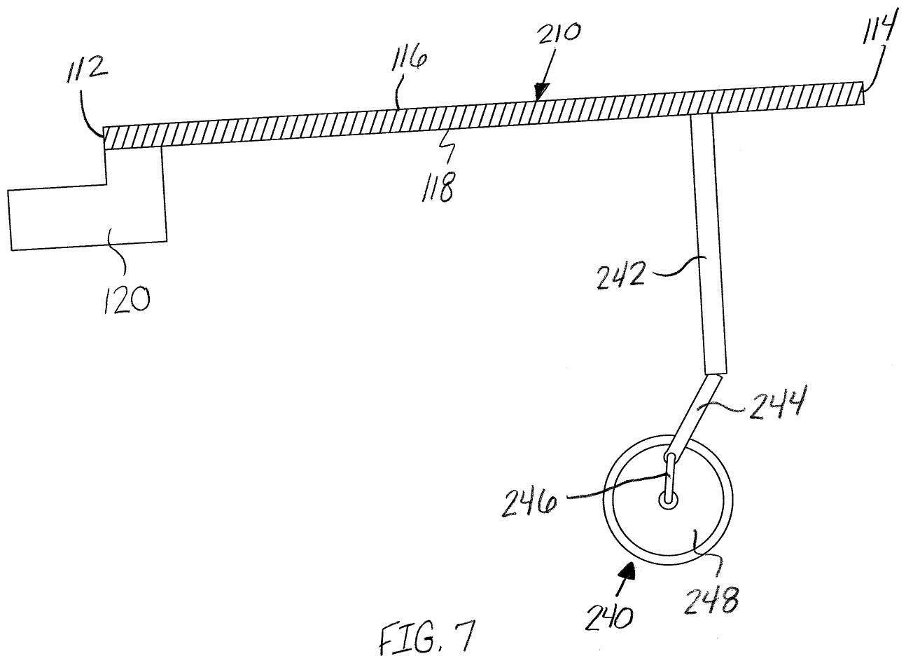

The counterweight 120 pulled down by the pull of gravity rapidly moves the pivoting treadle plate 110 or a pivot plate flap, as discussed in greater detail below, to be angled upward relative to the surface of a roadway to a first position for the wheels of automobiles and trucks to drive upon to depress to a second position to be substantially level and flush with the roadway 102, 104. The counterweight 120 bias the upward pivoting treadle plate 110 minimally to provide only slight resistance to the weight and speed of motor vehicles and thereby provide a smooth ride at speed. The counterweight 120 is described in further detail below with reference to FIGS. 5-9.

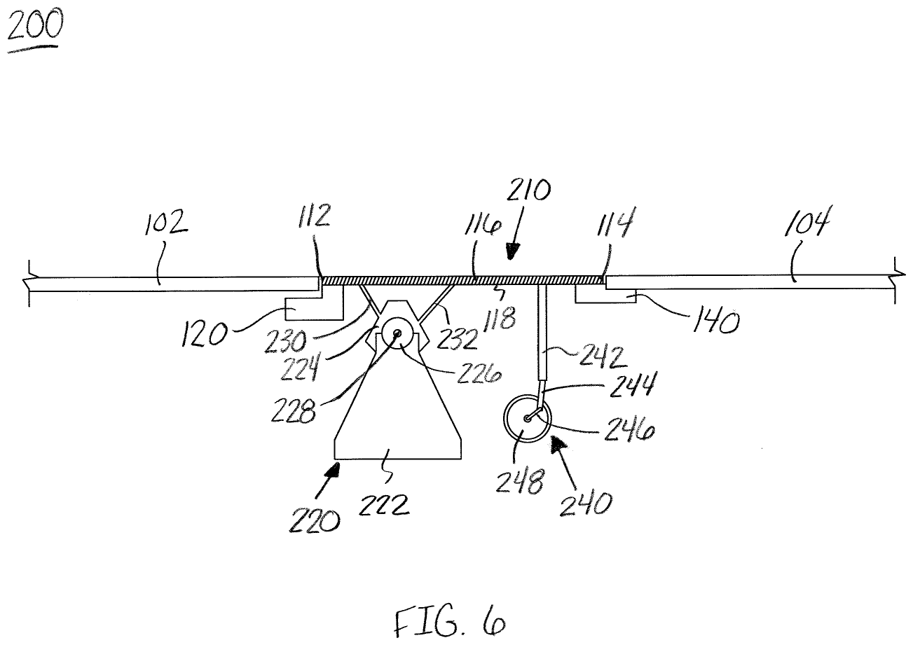

Also, as shown in FIGS. 1-2B, the plate 110 may be pivotally mounted on at least one shaft system or pivot system 130 allowing for rotation of the plate 110 relative to the rotating shaft system 130. A rotating shaft of the shaft system 130 is arrayed perpendicularly to the axis of the longitudinal axis of the pivoting treadle plate 110. The shaft system 130 may be, for example, as described in greater detail below with respect to pivot assembly 220. The shaft system 130 is mounted on and supported by a base that is part of a substructure (not shown) that is disposed in the excavation beneath the roadway. The treadle system 100 may also include a rest or rest member 140 coupled to a bottom surface of the second piece of road 104. The rest 140 may extend away from the second road piece 104 into the space below the plate 110. The rest member 140 may engage the bottom surface 118 of the plate 110 at the second end 114 to support the pivoting treadle plate 110 upon the surrounding road pieces 102, 104. The rest member 140 may be, for example, a rest, ledge, or other support member that is supported by the roadway or a substructure below the roadway. The substructure could have a surface configured to support the pivoting treadle plate or leaf 110, 210 to rest upon at its forward toe in the lowered horizontal position, as shown in FIG. 6. When the distal forward toe edge or second end 114 of the plate 110, 210 is level in the horizontal position the edge 114 rests on the member 140 to support the pivoting load bearing treadle plate 110, 210 in its horizontal position adjacent to the forward portion of the roadway.

In addition, as shown in FIGS. 2A-2B, the system 100 may include a turbine assembly or mechanism 132, which in some embodiments may be fixed or movably coupled to and extending from an underside of the plate 110. The turbine assembly 132 may be, for example, the turbine systems or mechanisms 240, 260 as described in greater detail below and which will not be described here for brevity sake.

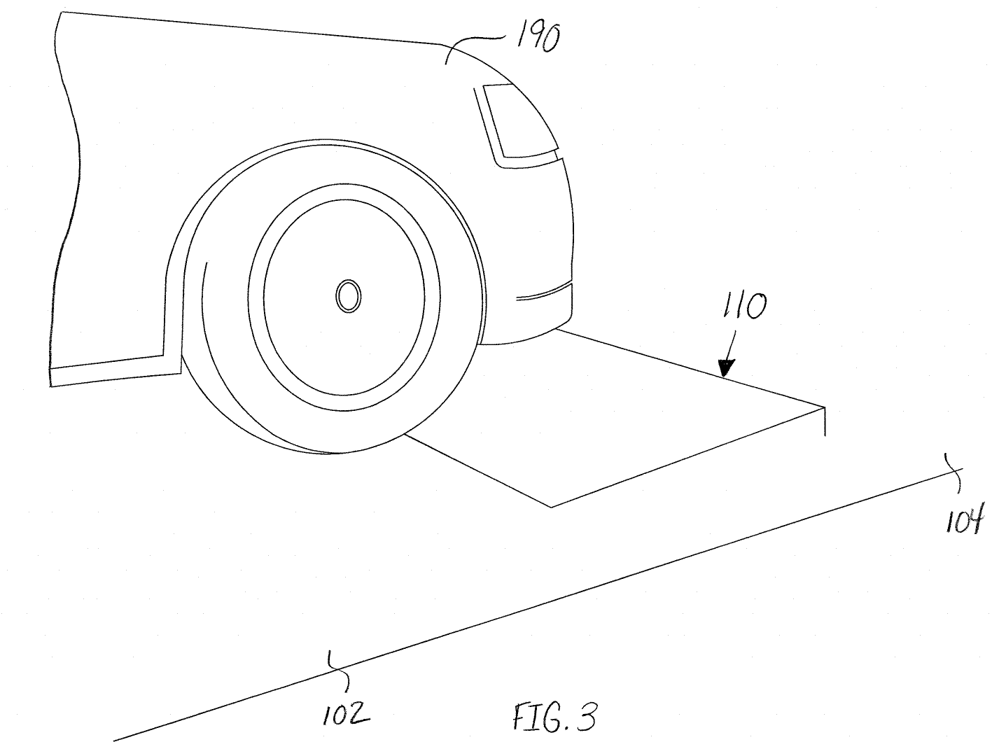

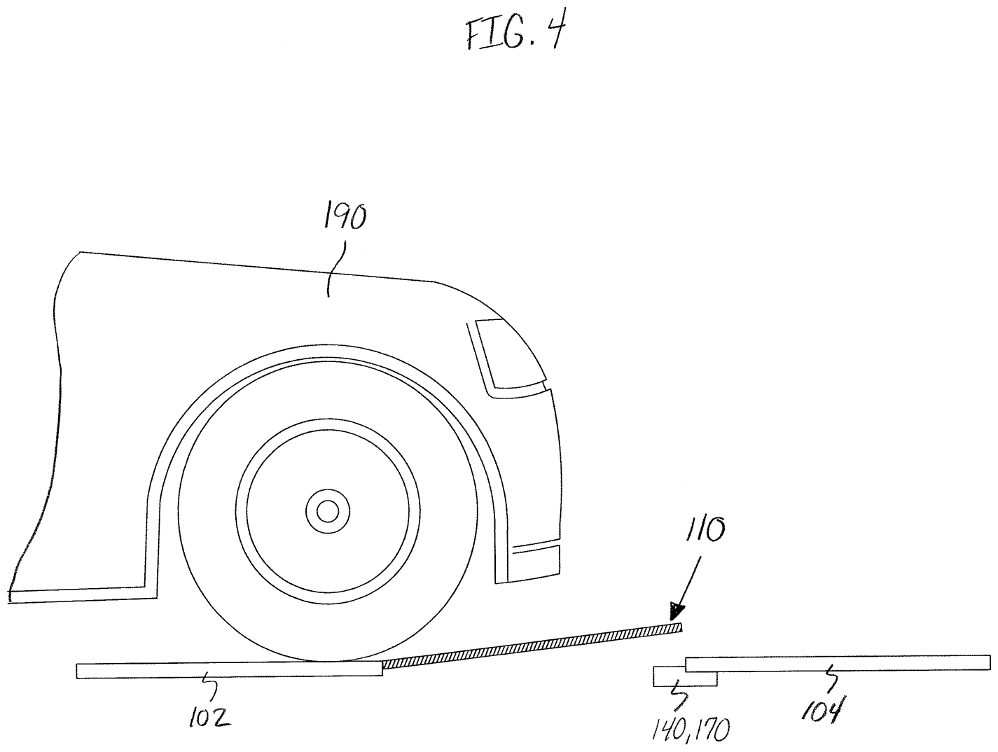

Referring now to FIGS. 3-4, an exemplary road-embedded vehicle-actuated treadle system 100 is shown as a car 190 approaches the plate 110. Below the plate 110 an excavation, recess, or pit is created to receive the downshaft 242, frame, substructure, or base of the traffic turbine system 100 and an electric power generation system, as described in greater detail below. The electric power generation system allows for kinetic energy from movement of vehicles over the plates 110 to be transformed into electricity. For example, the vehicles movement of the plates 110 may allow for rotation and driving of at least one generator, as described in greater detail below.

An angled pivoting treadle plate 110 can be adjusted to provide sufficient clearance for the undercarriage of motor vehicles and is also actuated by the driving over it to depress the distal end 114 of the plate 110 to a position that is substantially horizontal with the road surface 104. By way of illustration, pivoting treadle plate 110 or pivoting flap, described below, with a longitudinal distance of, for example, approximately thirty-six inches from it approach end to its distal forward end 114, with its distal forward end 114 raised to, for example, approximately five inches that is driven over by a vehicle 190 whose forward edge of the bumper is, for example, approximately five inches from the ground and, for example, twenty-five inches from where the front wheels come in contact with the ground would never scrape against the pivoting treadle plate 110 or pivoting flap. Similarly, when the pivoting treadle plate 110 or pivoting flap is depressed to being level with the ground, if the longitudinal distance from the approach end 112 to the forward end 114 of the plate 110 is, for example, approximately seventy-two inches, even if the forward end of the pivoting treadle plate 110 or pivoting flap is, for example, approximately ten inches, it will not scrape the bottom of the bumper or the rest of the vehicle 190, so long as it is not raised while the vehicle 190 straddles the plate 110. For many cars 190 the clearance point from the ground to the bottom of the front bumper for clearance is, for example, around 4-6 inches. If the plate or ramp 110 at its distal forward edge 114 rises higher than the bottom of a motor vehicle 190, another way to provide clearance is to make the run of the pivoting load bearing treadle plate 110 or flap plate, such as flap plate 310 as described in greater detail below, longer and/or adjust the speed at which the plate 110 pivots the load-bearing plate 110 back up to allow the vehicle 190 to pass entirely over the load-bearing plate 110 before it is raised again.

Referring now to FIGS. 5-8, a gravity counterweight and vehicle-actuated treadle system 200 is shown. The treadle system 200 is mounted on and supported by a substructure frame (not shown), which in some embodiments may include a trench box (not shown) or standalone frame (not shown). The system 200 includes a pivoting treadle plate 210 positioned between the first road piece 102 and the second road piece 104, a pivot assembly 220, and a turbine assembly or mechanism 240. The plate 210 may have a first end 112, second end 114, top surface 116, and bottom surface 118, as described above with reference to plate 110 which will not be described again here for brevity sake. The plate 210 may also include a counterweight 120 coupled to and extending from the first end 112 of the plate 210 and a rest member or member 140 coupled to and extending from the second end 114 of the plate 210. The rest member 140 is as described above with reference to plate 110 and will not be described again here for brevity sake.

With continued reference to the discussion above of the counterweight 120 with respect to plate 110, the counterweight 120 of plates 110, 210 is positioned beneath the roadway and configured for the gravitation force pulling the counterweight 120 downwards to produce an upward force upon the pivoting treadle plate 110, 210 to return the plate 110, 210 to a raised starting position. The counterweight 120 may be, for example, weighted to actuate raising and maintain the pivotally responsive plate 110, 210 to project in the open position at a desired slight angle above the upper surface of the roadway. The counterweight 120 may be fixed to the approach side 112 of the plate 110, 210 on the approach side 112 of the transverse pivot shaft 130, 226 or may be articulated to move, but in either case will allow the approach side 112 of the plate 110, 210 when it is either raised to an angle or when it is depressed to the horizontal position to be nearly adjacent with the approach side 112 of the roadway 102. Preferably, the counterweight 120 will be angled so that when it is actuated to be raised, it does not come in contact with the approach road. Thus, the plate 110, 210 may be inclined or angled from flush at a position proximate to the approach edge 112 of the plate 110, 210 to a raised position at the distal forward edge 114 of the plate 110, 210, actuated by the pull of gravity upon the counterweight 120. The counterweight 120 will be balanced with the weight of the pivoting treadle plate 110, 210 with slight bias to provide little resistance to vehicles passing over the plate 110, 210. In some embodiments, the counterweight 120 will be configured to allow for adding or reducing the weight of the counterweight 120 mounted upon and supported by the plate 110, 210. The counterweight 120 will be positioned to carry most or all of its weight on the first side or approach side 112 of the plate 110, 210 to assist with maintaining the upward angle of the plate 110, 210. The counterweight 120 is actuated to move down by gravity to actuate the plate 110, 210 by pivoting about the rotating shaft 130, 226 that is arrayed perpendicularly from the longitudinal axis of the axis of the pivoting treadle plate 110, 210. Before a vehicle passes over the plate 110, 210, the counterweight 120 is in a lower position, then once the vehicle drives onto the plate 110, 210, the counterweight 120 is raised by the weight of automobiles driving over the pivoting treadle plate 110, 210 to allow the plate 110, 210 to rotate and position the top surface of the plate 110, 210 flush with the top surface of the surround roadway 102, 104. After the vehicle leaves the plate 110, 210 and drives onto the adjacent road surface 104, the counterweight 120 is again actuated by gravity and moves causing the plate 110, 210 to raise again to its desired open angled position.

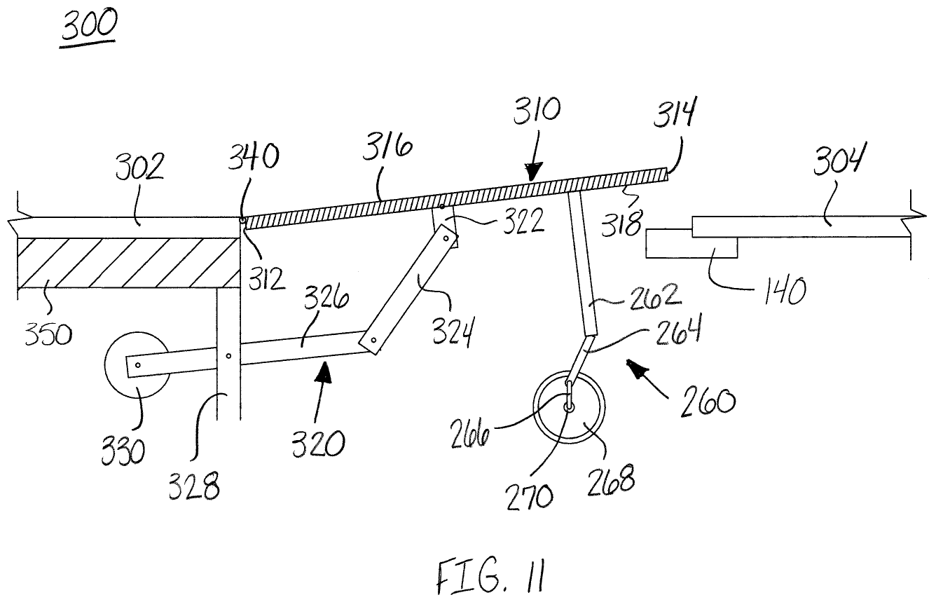

The counterweight 120 is preferably made of, for example, steel, cement, iron, tungsten or various alloys. In addition, the counterweight 120 may not be balanced and may be off center of gravity to allow gravitational force of the counterweight 120 to actuate tilting of the toe end 114 of the treadle plate 110, 210 to rise to and be maintained at the desired angle. In addition, the counterweight 120 may be adjustable and rigidly fixed to the pivoting treadle plate 110, 210. In alternative embodiments, the counterweight 120 may be linked to or articulated from the pivoting treadle plate 110, 210. As the treadle plate 110, 210 is pivoted each vehicle may engage both the counterweight 120 and the reciprocal action of the first driving flywheel 248, 268, crank 246, 266, Pitman arm 244, 264, and connecting mechanism 240, 260 that provide rotational mechanical energy to turn the first driving flywheel 248, 268. In some embodiments, the counterweight 120 may be articulated or indirectly or movably coupled to the plate 110, 210. While in other embodiments, the counterweight 120 may be rigidly mounted or directly mounted to the plate 110, 210. It is also contemplated, that the counterweight 120 may be implemented including a four bar link coupled to the lower surface of the plate 110, 210, as described in greater detail below with reference to FIG. 11. In yet another embodiment, the counterweight 120 may be mounted on a superstructure above the surface of the roadway. In some embodiments, the shaft system 130 and turbine assembly may be mounted underneath the counterweight (not shown).

With continued reference to FIGS. 5-8, the pivot assembly 220 includes a base 222 mounted on a substructure frame (not shown), a pivot member 224 movably coupled to the base 222 by a rotating shaft 226, and at least one arm 230, 232 coupled to the pivot member 224 on one end and the plate 210 on another end. The shaft 226 may rotatably engage the base 222. The shaft 226 may also include a pivot point 228 about which the shaft 226 rotates to allow for the plate 210 to pivot relative to the top surface of the surrounding road. The pivot member 224 also rotates about the pivot point 228 and also preferably in some embodiments to allow for the at least one arm 230, 232 to move the plate 210 each time a vehicle tire passes over the plate 210. The at least one arm 230, 232 may be, for example, a first arm 230 extending in a first direction from the pivot member 224 and a second arm 232 extending in a second direction from the pivot member 224. The first direction may be, for example, towards the first end 112 of the plate 210 and the second direction may be, for example, towards the second end 114 of the plate 210. Specifically, the pivoting member 224 may assist with rotating the plate 110, 210 back to a starting angled position based on the force applied by the counterweight 120.

In one embodiment, as shown in FIGS. 5-8, the turbine assembly 240 may include a drive shaft, downshaft, or connecting member 242 coupled to and extending from the underside 118 of the plate 210, and an arm or Pitman arm 244 extending from the distally lower portion of the drive shaft 242 to a crank 246. In some embodiments, the crank 246 rotates a rotating drive shaft 250 that has a mounted flywheel 248 coupled to the rotating shaft 250. The drive shaft 242 extends away from a bottom surface 118 of the plate 210, for example, perpendicular to the bottom surface 118, but may in some embodiments be movable or tiltable. The drive shaft 242 is fixedly or movably attached, for example, mounted, fastened to, or supported on, and operatively coupled to the underside or lower surface 118 of the pivoting treadle plate 210 proximate to its distal, forward side, or toe 114. The Pitman arm 244 may be coupled at a first lower distal end to the drive shaft 242 and at a second end to the crank 246. The Pitman arm 244 may be, for example, angled as it extends from the drive shaft 242. The first end of the crank 246 may extend away from a second end of the Pitman arm 244 and change angulation relative to the Pitman arm 244 during pivoting of the plate 210. The Pitman arm 244 may be, for example, configured to drive rotation of at least the flywheel 248. The second end of the crank 246 may be coupled in some embodiments to the flywheel 248 and in other embodiments to a rotating shaft 250. The crank 246 is movably attached to the Pitman arm 244 and the crank 246 actuates rotation of the first flywheel 248 or in other embodiments the rotating shaft 250 upon which is rotatably mounted a rotating flywheel 248. As shown in FIG. 5, the plate 210 is positioned in a first or ready position awaiting activation by a vehicle. Once a vehicle drives onto the plate 210, the plate 210 moves to a position flat or flush with the surrounding road, as shown in FIG. 6. As the plate 210 pivots, the movement of the turbine assembly 240 rotates the flywheel 248, which in turn creates energy for the generator either directly or through a gearbox, discussed in greater detail below. Although, the drive shaft 242 and Pitman arm 244 are shown and described as single units, it is also contemplated that the drive shaft 242 and Pitman arm 244 may be, for example, telescoping rods with struts, springs, and pistons, to lengthen the stroke of the drive shaft or a shock absorber mounted on the Pitman arm 244 to absorb shock from the arm being driven down by the plate 210.

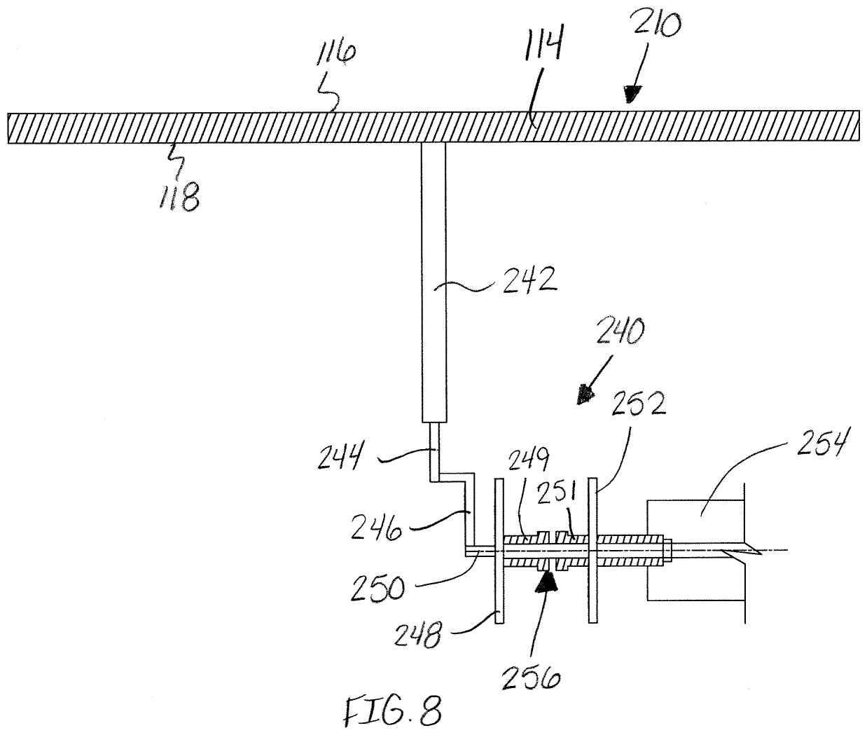

As shown in FIG. 8, the turbine assembly 240 also includes a horizontal rotating shaft 250 coupling the crank 246 to at least the flywheel 248. The flywheel 248 is mounted on the rotating shaft 250. The turbine assembly 240 also includes a freewheel flywheel or second flywheel 252 and a generator 254. The freewheel flywheel 252 is positioned spaced apart from and adjacent to the flywheel 248. The freewheel flywheel 252 is mounted on the rotating shaft 250 and is driven by the first flywheel 248 and rotating shaft 250. The freewheel flywheel 252 and flywheel 248 are operably coupled together and spaced apart by a ratchet or overriding clutch 256. The second flywheel 252 is driven using the rotating shaft 250 which is rotationally coupled to transmit rotational force, directly or indirectly, to spin a generator 254 to generate electricity. The ratchet 256 includes a first portion or driving rotating shaft 249 and a second portion or driven rotating shaft 251. The flywheel 248 is rotatably mounted to the driving rotating shaft 249. The driving rotating shaft 249 extends from the second side of the rotating shaft 250 to a directional coupling interposed between the driving rotating shaft 249 and the driven rotating shaft 251 to provide rotational force to rotate the driven rotating shaft 251 and also allow the driven rotating shaft 251 to move faster.

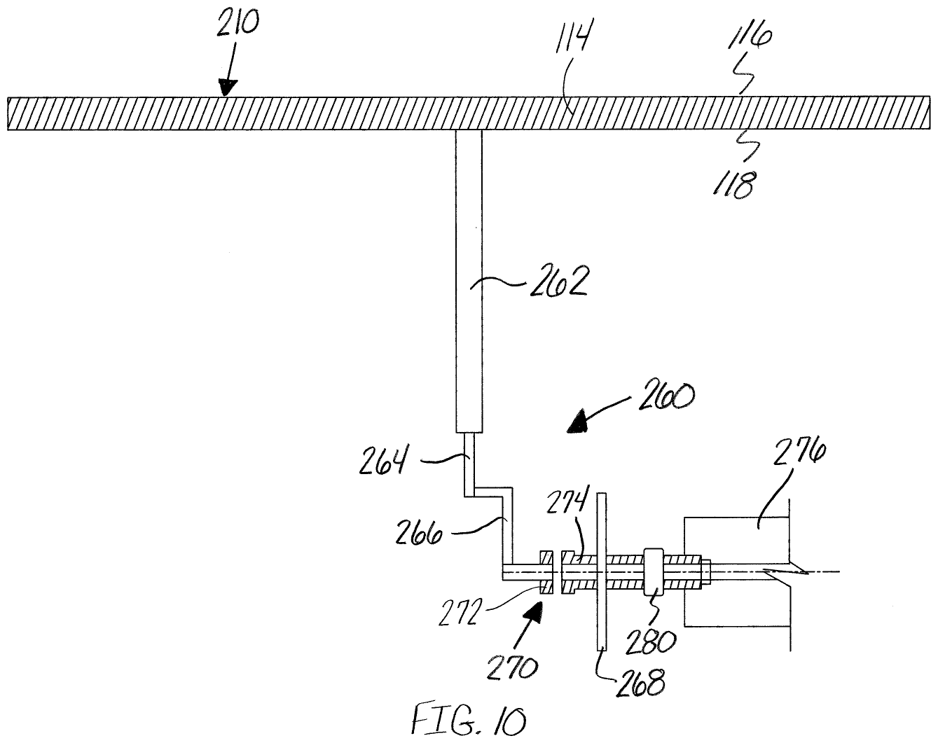

With continued reference to FIG. 8, the depressing of the treadle plate 210 drives down the drive shaft 242 that is coupled to the plate 210. As the drive shaft 242 is driven down, the Pitman arm 244 that is mounted to the drive shaft 242 is pushed downward by the force of the pivoting plate 210. The downward actuation of the operatively coupled drive shaft 242 and Pitman arm 244 at the lower end of the drive shaft 252 rotates an operatively coupled crank 246 attached to the driving flywheel 248. As the crank 246 rotates the flywheel 248, linear force is converted into rotary force and rotational movement is imparted onto the first driving flywheel 248. The flywheel 248 is rotationally mounted on a driving shaft 249 and as the rotating shaft 250 is turned by the crank 246, the rotating shaft 250 rotates and projects the rotation outwardly on the second side of the first flywheel 248. The rotating shaft 250 and flywheel 248 rotate the driving shaft 249, which in turn engages the adjacent driven shaft 251 for rotation. The driving shaft 249 and driven shaft 251 may disengage from each other to allow the driven shaft 251 to rotate freely and when the driven shaft 251 rotates fastener than the driving shaft 249. The driven shaft 251 may also continue to rotate when the driving shaft 249 is stopped. The driven shaft 251 may also be secured to the substructure. The second flywheel 252 operatively coupled to the driven shaft 251 which is operatively coupled to the driving shaft 249 to actuate rotation of the flywheel 252. The flywheel 252 is mounted to rotate with little resistance upon the driven shaft 251 and allows for the kinetic energy of the rotation of the flywheel 252 to be capable of transmitting a large torque that imparts rotation to spin a linked and operationally coupled generator 254 to generate electricity. The rotor (not shown) of the generator 254 is rotatable by depression of the plate 210 transferred via the drive shaft 242, Pitman arm 244, and crank 246 to the flywheel 248 to introduce rotational energy to drive the electrical generator 254 to produce electrical energy. In some embodiments, the operatively coupled generator will include a gearing system (gear drive system), such as gearing system 280 discussed in greater detail below in FIG. 10, interposed between the first driving flywheel 248 and the generator 254. In addition, a cable (not shown) from the generator 254 evacuates the electrical energy which can be transmitted to, for example, a grid, micro grid, industrial facility or the like, or for charging and/or storage in batteries. When necessary, the system 200 provides means for converting between AC and DC power to make it acceptable for transmission to a power grid.

In other embodiments, the rotating shaft 242 upon which the crank 246 is mounted may engage the rotating shaft 250 upon which the flywheel 248 is rotationally mounted through one or more ratchet mechanisms that enable the at least one flywheel 248 to be a freewheel flywheel to rotate independently and faster than the one or plurality of input rotating shafts 242, 250 or input crank 246. In yet other embodiments, the rotating shaft 250 between the first flywheel 248 and the rotating shaft upon which second freewheel flywheel 252 is rotatably mounted engage through a ratchet mechanism 256 to allow the second freewheel flywheel 252 to spin independently and faster than the first flywheel 248. The freewheel ratchet mechanisms 256 are mounted between adjacent driving and driven rotating shafts 249, 251 configured to allow the driven flywheel 251 to spin faster so that the freewheel flywheel 252 can continue providing speed and/or rotational torque to the adjacent driven shaft on which is rotationally mounted the freewheel flywheel 252. The ratchet 256 further allows the driven rotating shaft 251 to turn faster than the driving shaft 249 and also keep rotating when the driving shaft 249 has stopped. The adjacent driving shaft 249 and driven shaft 251 are coupled in a direction that the driving shaft 249 provides torque to the driven shaft 251, yet decouples when the driven shaft 251 rotates faster. In some embodiments, the directional coupling is in only one direction. In yet other embodiments, the rotating shaft between the first flywheel 248 and the adjacent rotating shaft upon which the second freewheel flywheel 252 is rotatably mounted engage through a ratchet mechanism 256 to allow the second freewheel flywheel 252 to spin independently and faster than the first flywheel 248. In other embodiments, the ratchet mechanism 256 is interposed between the rotating shaft 244 on which the crank 246 is rotatably mounted and adjacent rotating shaft 250 upon which the first flywheel 248 is mounted. In additional embodiments, the ratchet mechanism 256 is interposed between the adjacent rotating shaft 250 on which the first flywheel 248 is mounted and the adjacent rotating shaft upon which the freewheel flywheel 252 is mounted. In still other embodiments, the output rotating shaft between the second flywheel 252 and generator 254 spins the at least one linked generator 254 directly, while in yet other embodiments the output rotating shaft is linked to a gearbox, such as gearbox 280 discussed in greater detail below in FIG. 10, to increase or decrease the rotational the speed or force of rotation going to spin the at least one generator 254.

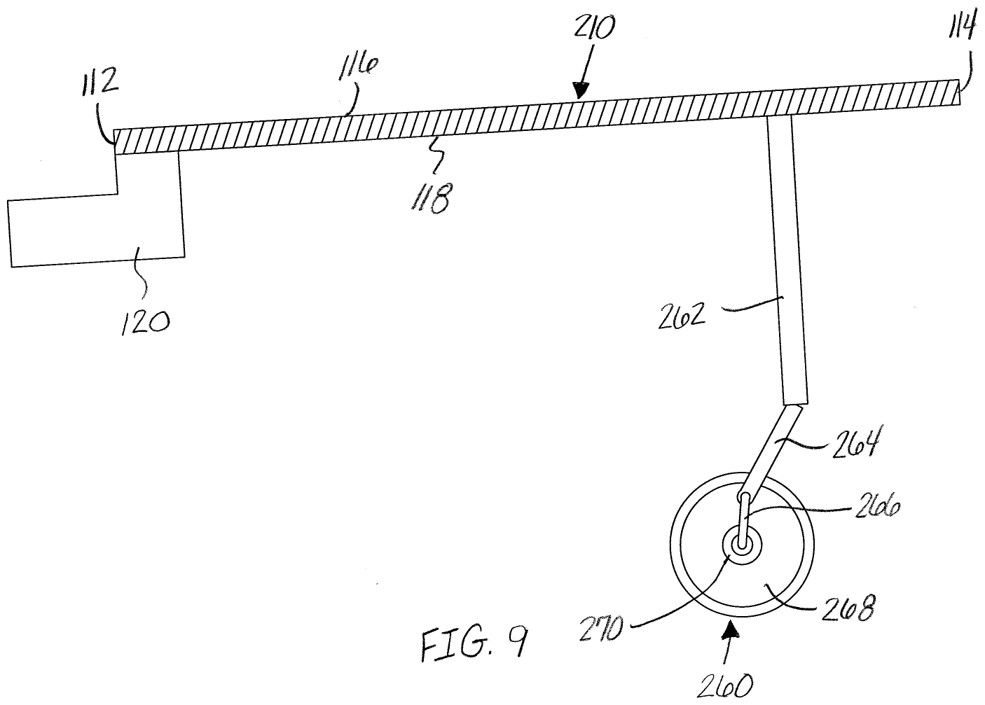

Referring now to FIGS. 9-10, an alternative turbine assembly 260 is shown. The turbine assembly 260 is coupled to and extends from the bottom surface 118 of the plate 210. The turbine assembly 260 includes a drive shaft or connecting member 262 coupled to and extending from the plate 210, a Pitman arm or arm 264 extending from the drive shaft 262 to a crank 266, and a flywheel 268 coupled to the crank 266. The drive shaft 262 extends away from a bottom surface 118 of the plate 210, for example, perpendicular to the bottom surface 118 but may in different embodiments be moveable or tiltable. The downshaft drive shaft 262 is attached, for example, mounted, fastened to, or supported on, and operatively coupled to the underside or lower surface 118 of the pivoting treadle plate 210 proximate to its distal, forward side, toe 114. The Pitman arm 264 may be coupled at a first end to the drive shaft 262 and at a second end to the crank 266. The Pitman arm 264 may be, for example, angled as it extends from the drive shaft 262. The arm 264 may be, for example, configured to drive rotation of at least the flywheel 248. The first end of the crank 266 may extend away from a second end of the Pitman arm 264 and change angulation relative to the Pitman arm 264 during pivoting of the plate 210. The second end of the crank 266 is coupled, directly or indirectly, to the flywheel 268. The turbine assembly 260 also includes a ratchet mechanism 270 positioned to engage the crank 266. Although, the drive shaft 262 and Pitman arm 264 are shown and described as single units, it is also contemplated that the drive shaft 262 and Pitman arm 264 may be, for example, telescoping rods with struts, springs, and pistons, to lengthen the stroke of the drive shaft or a shock absorber mounted on the Pitman arm 264 to absorb shock from the arm being driven down by the plate 210.

As shown in FIG. 10, the turbine assembly 260 also includes a generator 276 operably coupled to the ratchet mechanism 270. The ratchet mechanism 270 includes a first portion 272 and a second portion 274. The first portion 272 couples to the second end of the crank 266 or to the rotating shaft 250. The second portion 274 is positioned with the first end positioned and aligned with the second end of the first portion 272. The second portion 274 extends away from the first portion 272 and couples to the flywheel 268 directly or to the rotating shaft 274. The flywheel 268 may be positioned near the first end of the second portion 274. The second end of the second portion 274 engages the generator 276. The second portion 274 may, for example, directly engage the generator 276 or indirectly engage the generator 276 via a gearbox 280 or the like.

A method of using the vehicle-actuated treadle systems 100, 200 is also disclosed. The method includes positioning turbine assemblies or mechanisms 240, 260 in a recess, for example, under the road, in a median, shoulder or beside the road. After the turbine assembly 240, 260 is positioned under the roadway, a plate 110, 210 is positioned over the recess and coupled to the turbine assembly 240, 260 and a pivot system 130 or a pivot assembly 220 also positioned in the recess under the roadway. The plate 110, 210 may be made of, for example, steel, carbon fiber, aluminum or another material that can bear the load of vehicle road traffic. The counterweight 120 with assistance of the pivot system 130 or pivot assembly 220 allows the plate 110, 210 to be positioned at a slight angle relative to the top surface of the roadway and flush with the top surface of the roadway. As vehicles drive over the roadway the plate 110, 210 is actuated by the kinetic energy of the vehicles and pivots the plate 110, 210 from angled to be level or flush with the road surface. The downward movement of the plate 110, 210 from angled to level or flush with the road surface by the wheels of a vehicle transmits power to a turbine assembly 240, 260. The pivoting treadle plate 110, 210 pivots about the pivot system 130 or the rotating shaft 226 of the pivot assembly 220, respectively, moving the plate 110, 210 from an angled open position to a closed horizontal position flush with the roadway by the speed and weight of vehicles engaging the upper surface of the plate 110, 210. The pivoting of the plate 110, 210 imparts power to a shaft 242, 262 converted to impart rotary power to one or more linked flywheels 248, 252, 268 to spin a generator 254, 276 for generating electricity. After the vehicle leaves the plate 110, 210, the plate 110, 210 rotates back to the starting angled position to await another vehicle. The plate 110, 210 rotates back with the assistance of the counterweight 120 and the pivot system 130 or the pivot assembly 220.

In accordance with one or more embodiments, a method is disclosed of generating energy by moving a pivoting treadle plate 110, 210 disposed on a roadway actuated by the pull of gravity upon a counterweight 120 to pivot the pivoting treadle plate 110, 210 to be angled upwards relative to the surface of the roadway in a first position for automobiles to drive upon, and in some embodiments, method for actuation by the weight and movement of automobiles and trucks driving upon it to depress the pivoting treadle plate 110, 210 to a second position to be substantially level and flush with the roadway and also raises the counterweight 120 upward within the excavation beneath the road. The traffic turbine generator comprises a substructure disposed in a recess under a road that supports a rotating shaft 130, 226 on which a pivoting treadle plate 110, 210 is mounted and serves as the pivot point for the pivoting treadle plate 110, 210 and for the counterweight 120 actuated by the pull of gravity mounted on the first edge 112 of the pivoting treadle plate 110, 210 to angle it upward relative to the surface of the roadway in a first position for automobiles to drive upon, wherein the speed and weight of the automobiles and trucks driving upon it depresses the treadle plate 110, 210 to a second position substantially level and flush with the roadway, wherein depressing the pivoting treadle plate 110, 210 moves a downshaft 242, 262 attached to and extending downward from the underside 118 of the treadle plate 110, 210 downward, wherein at the lower end of the downshaft 242, 262 is attached a Pitman arm 244, 264 and driving the downshaft 242, 262 downward also moves the linked Pitman arm 244, 264 downward to engage a crank 246, 266 to move the crank 246, 266 in a rotational motion to rotate rotating shafts 250, one or a plurality of flywheels 248, 252, 268 rotatable mounted on rotating shafts 250, and in embodiments utilizing on or a plurality of ratchet mechanisms 256, 270 and in some embodiments, one or a plurality of freewheel flywheels 252, 268 to rotate independently and faster, and in other embodiments output shafts and/or a gearbox 280 to impart rotational movement to spin a linked generator 254, 276. The method comprises the steps of the pull of gravity actuating the pivoting treadle plate 110, 210 to pivot upwards, the speed and weight of vehicles depressing the pivoting treadle plate 110, 210 from the angled position to a horizontal position such that a downshaft 242, 262 with an attached Pitman arm 244, 264 is extended downward and the Pitman arm 242, 262 engages the crank 246, 266 to move in a rotational movement to rotate rotational shafts 250 upon at least one flywheel 248, 252, 268 is attached, wherein the rotation of the rotational shafts 250 may be direct or by utilizing ratchets 256, 270 that power a freewheel flywheel 252, 268 to spin independently and/or faster than the rotational speed of the preceding rotating shaft 250 or in certain embodiments, of the preceding flywheel 248, wherein the output shaft extending from the freewheel flywheel 252, 268 rotates to either directly or through a gearbox 280 spin a linked generator 254, 276.

Although the above method is described with only one plate 110, 210, it is understood that one or a plurality of plates 110, 210 may be disposed across the surface of one or more lanes of a roadway over one or more pits underneath the roadway. In addition, the turbine mechanism 240, 260 may include one or more drive shafts 242, 262 and Pitman arms 244, 264. Additionally, one or a plurality of generators 254, 276 may be utilized, either individually or connected by electrical transmission lines. Further, although only a single system 100, 200 is disclosed in the above method, the systems 100, 200 may include, for example, one standalone system 100, 200 or a plurality of mechanically or electrically connected systems 100, 200.

As shown in FIGS. 1-4, the roadway surrounding the plate 110, 210 may include a near approach side where the vehicles approach the plate 110, 210 to engage it. The roadway surrounding the plate 110, 210 may also include a distal forward far side of the roadway to where the vehicles move after they pass over the treadle system 100, 200. The recess, pit or excavation positioned in the ground below the plate 110, 210 contains vertical sides sufficient to contain the mechanisms, assemblies, framework and structure of the power generation system including the pivot system 130 or pivot assembly 220 and the turbine assembly 240, 260. The recess also includes columns and footings to carry the load of the pivot system 130 or pivot assembly 220, turbine assembly 240, 260 and plate 110, 210. The horizontal rotating shaft 250 of the turbine assembly 240 may be positioned, for example, proximate to the approach end of the roadway and transversely across at least one lane under the roadway at an axis perpendicular to the longitudinal center line of the roadway.

Referring now to FIG. 11, another pivoting treadle plate system 300 is shown. The system 300 includes a plate or flap 310 positioned between a first road piece 302 and a second road piece 304. The system 300 also includes a counterweight system 320 coupled to and extending from the bottom surface 318 of the plate 310. The system 300 may include a turbine assembly or mechanism 260 coupled to and extending from an underside of the plate 310 and generator 276, as discussed in greater detail above and which will not be described again here for brevity sake. The system 300 further includes a hinge member 340 coupling the first end 312 of the plate 310 to the first road piece 302 on the approach side of the roadway. The hinge member 340 allows for the plate 310 to angle relative to the first road piece 302 when gravity is applied to the counterweight 320. When a vehicle drives over the plate 310, the hinge member 340 allows the top surface 316 of the plate 310 to rotate to be flush with the top surface of the surrounding roadway 302, 304 due to the weight of the vehicle. After the vehicle leaves the plate 310, the second end 314 of the plate 310 will move away from the second road piece 304 as gravity is once again exerted upon the counterweight system 320 and the first end 312 of the plate 310 will rotate about the hinge member 340 returning the plate 310 to a first angled position.

The counterweight system 320 may include, for example, a four bar arrangement 322, 324, 326, 328 and a counterweight 330. The four bar arrangement includes a first bar 322 with a first end coupled to and extending from an underside of the flap 310, a second bar 324 with a first end hingedly or rotatably coupled to a second end of the first bar 322, a third bar 326 with a first end hingedly or rotatably coupled to a second end of the second bar 324, and a fourth bar 328 coupled to and extending from an underside or bottom surface of a support member 350 positioned beneath the first road portion 302. The third bar 326 may be, for example, hingedly or rotatably coupled between the first end and the second end to the fourth bar 328. The counterweight 330 may be coupled to the second end of the third bar 326. The counterweight 330 raises a toe end 314 of the flap 310 when gravity is applied, then once a car drives over the flap 310, the counterweight 330 is raised thereby lowering the flap 310 and allowing for the turbine mechanism, such as turbine mechanisms 240, 260, to be activated and energy generated.

The flap 310 may be, for example, one flap 310 across the entire approach end of the pit or a plurality of flaps 310 spaced apart along the approach end 312 of the treadle system 300. The flap 310 may include a heel flap that extends from the upper road surface and the distal forward end of the flap 310 may be raised to a desired incline angle by the use of a counterweight system 320.

In another embodiment, the horizontal rotating shaft 250 of the turbine assembly 240 may be, for example, rotationally attached to a slab of pavement proximate to the approach pivotally mounted and supported upon the horizontal transverse pivot shaft for support or pivoting.

In addition, in another alternative embodiment, a drive shaft may be attached proximate to the underside of the counterweight 120. The drive shaft may be linked to and responsive to raising the treadle plate to its angled position by the downward movement of the counterweight 120, wherein when vehicles pass beyond the treadle plate 110, 210 and gravity actuates the counterweight 120 to be driven downward to cause an upward pivot of the treadle plate 110, 210, the driving shaft or arm beneath the counterweight 120 is driven downward to actuate a second drive shaft to cause a Pitman arm to rotate a flywheel. The system may include drive shafts both at underside of toe end of treadle plate 110, 210 and underside of counterweight 120, wherein on the lower or distal end of the drive shaft or arm is configured an attached Pitman arm configured to drive rotation of a rotating crank attached to a first driving flywheel about a rotational axle.

It is also contemplated that the distal forward toe end of the plate 110, 210, 310 may include or be configured with a lock or locking mechanism to secure the plate 110, 210, 310 in a horizontal close position, for example, when there is snow or rain. In alternative embodiments, the recess or pit may be reinforced with concrete walls, trenchbox, frame, or shield to protect the turbine mechanism 240, 260 from water, snow, dust, mud and prevent cave-ins. Alternatively, the turbine mechanism 240, 260 may be completely sealed in a housing for weather protection.

Further, the plate 110, 210, 310 may include a brake mechanism (not shown) that may control the desired slope or angle that the plate 110, 210, 310 pivots to when in use. The brake mechanism may, for example, limit upward motion of the plate 110, 210, 310. The brake mechanism may be, for example, a chain, rope, rod, linkage, or the like. In addition, the slope desired angle or height of the distal toe end of the plate 110, 210, 310 may be adjustable. In yet another embodiment, the time it takes for raising the plate 110, 210, 310 upward may be adjusted by means of a governor or controller (not shown).

In some embodiments, a supplementary plate or some other exemplary resilient covering movably attached and engaging the first edge or second edge of the plates 110, 210, 310 and overlapping the road surface can be utilized to provide smooth transition from the road surfaces onto the pivoting treadle plate 110, 210, 310 or the pivoting plate and may also be utilized in embodiments to provide desired further weather protection.

In order to prevent vehicle damage during use of the systems 100, 200, 300, known traffic signs may be used. Such as, lane markers or cones to show that drivers are prohibited from changing to such marked lanes. Examples include double yellow lines and markers that certain lanes are strictly for high occupancy vehicles or buses. This would prevent automobiles from attempting to change lanes into a raised plate 100, 210, 310. In addition, exit ramps frequently have only one lane and are therefore not subject to lane changing.

It is also contemplated that cameras or sensors may be arrayed at each generator assembly to detect vehicles to make adjustments to the rise of the distal side of the plate 110, 210, 310 or to provide compensation to the drivers of vehicles for using the lane with the generator assembly to generate power.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The invention has been described with reference to the preferred embodiments. It will be understood that the architectural and operational embodiments described herein are exemplary of a plurality of possible arrangements to provide the same general features, characteristics, and general system operation. Modifications and alterations will occur to others upon a reading and understanding of the preceding detailed description. It is intended that the invention be construed as including all such modifications and alterations. In particular, acts, elements and features discussed in connection with one embodiment are not intended to be excluded from similar or other roles in other embodiments. Additionally, elements and components described herein may be further divided into additional components or joined together to form fewer components for performing the same functions. Accordingly, the foregoing description and attached drawings are by way of example only, and are not intended to be limiting.

Having thus described the preferred embodiments, the invention is now claimed to be:

1. A gravity-actuated and vehicle-actuated treadle system for generating electric power, comprising:
a plate including a counterweight coupled to a first end of the plate;
a pivot assembly rotatably coupled to a bottom surface of the plate; and
at least one turbine assembly coupled to and extending from the bottom surface of the plate.

2. The vehicle-actuated treadle system of claim 1, wherein the at least one turbine assembly comprises:
a drive shaft coupled to the underside of the plate at a first end;
a Pitman arm coupled to the drive shaft at a first end of the Pitman arm;
a crank coupled to the Pitman arm on a first end of the crank;
horizontal rotating shafts
and at least one flywheel coupled to a horizontal shaft attached to a second end of the crank.

3. The vehicle-actuated treadle system of claim 2, wherein the crank is coupled directly to a first flywheel of the at least one flywheel.

4. The vehicle-actuated treadle system of claim 2, wherein the at least one flywheel comprises:
a first flywheel coupled to a rotating shaft attached to the second end of the crank; and
a second flywheel mounted on a rotating shaft spaced apart from the first flywheel.

5. The vehicle-actuated treadle system of claim 4, wherein the at least one turbine assembly further comprises:
a rotating shaft coupled to the crank on a first end and the first flywheel on a second end; and
a generator rotated to spin by at least the first flywheel.

6. The vehicle-actuated treadle system of claim 5, wherein the at least one turbine assembly further comprises:
a ratchet interposed between and coupled to adjacent horizontal shafts on which are mounted the first flywheel and the second flywheel.

7. The vehicle-actuated treadle system of claim 6, wherein the ratchet comprises:
a driving rotating shaft coupled to the rotating shaft on a first end; and
a driven rotating shaft engaging the driving rotating shaft on a first end and the generator on a second end.

8. The vehicle-actuated treadle system of claim 7, wherein the first flywheel is coupled to the driving rotating shaft and wherein the second freewheel flywheel is coupled to the driven rotating shaft.

9. The vehicle-actuated treadle system of claim 2, wherein the at least one turbine assembly comprises:
a drive shaft coupled to the plate at a first end;
a Pitman arm coupled to the drive shaft at a first end of the Pitman arm;
a crank coupled to the Pitman arm on a first end of the crank; and
a flywheel indirectly coupled to a second end of the crank.

10. The vehicle-actuated treadle system of claim 9, wherein the at least one turbine assembly further comprises:
a ratchet mechanism coupled to and configured between the crank on a first end and a generator on a second end.

11. The vehicle-actuated treadle system of claim 10, wherein the ratchet mechanism comprises:
a first portion coupled to the second end of the crank; and
a second portion rotatably engaging the first portion.

12. The vehicle-actuated treadle system of claim 11, wherein the flywheel couples to the second portion of the ratchet mechanism.

13. The vehicle-actuated treadle system of claim 2, wherein the pivot assembly comprises:
a base;
a shaft rotatably coupled to the base;
a pivoting member coupled to the shaft; and
at least one arm extends from the pivoting member and engaging the plate.

14. A traffic turbine system, comprising:
a vehicle-actuated treadle system, comprising:
a load-bearing pivoting treadle plate including a counterweight coupled to a first end of the plate, wherein the pivoting treadle plate is actuated by vehicles driving upon the pivoting treadle plate to be depressed to a substantially horizontal position, and wherein the counterweight actuated by gravity to pivot the plate to be angled upwards;
a pivot assembly rotatably coupled to a bottom surface of the plate; and
at least one turbine assembly coupled to and extending from the bottom surface of the plate;
at least one piece of road positioned at a first end of the plate;
an excavation below a road surface for receiving the pivot assembly and the at least one turbine assembly; and
at least one piece of road positioned at the distal second end of the plate.

15. The system of claim 14, wherein the at least one turbine assembly comprises:
a drive shaft with a first end and a second end, wherein the first end coupled to the plate;
a Pitman arm with a first end and a second end, wherein the first end of the Pitman arm is coupled to the second end of the drive shaft;
a crank with a first end and a second end, wherein the first end of the crank is coupled to the second end of the Pitman arm;
a rotating shaft with a first end and a second end, wherein the first end of the rotating shaft is coupled to the second end of the crank;
a driving rotating shaft with a first end and a second end, wherein the first end of the driving rotating shaft is coupled to the second end of the driving rotating shaft;
a driven rotating shaft with a first end and a second end, wherein the first end of the driven rotating shaft engages the second end of the driving rotating shaft;
a first flywheel rotatably coupled to the driving rotating shaft; and
a second freewheel flywheel spaced apart from the first flywheel and rotatably coupled to the driven rotating shaft; and
a generator coupled to the second end of the driven rotating shaft.

16. The system of claim 14, wherein the at least one turbine assembly comprises:
a drive shaft with a first end and a second end, wherein the first end coupled to the plate;
a Pitman arm with a first end and a second end, wherein the first end of the Pitman arm is coupled to the second end of the drive shaft;
a crank with a first end and a second end, wherein the first end of the crank is coupled to the second end of the Pitman arm;
a ratchet mechanism with a first end and a second end, wherein the first end of the ratchet mechanism is coupled to the second end of the crank, and wherein the ratchet mechanism comprises:
a first portion coupled to the second end of the crank; and
a second portion rotatably engaging the first portion;
a freewheel flywheel rotatably coupled to the second portion of the ratchet mechanism; and
a generator coupled to a second end of the second portion of the ratchet mechanism.

17. The system of claim 14, wherein the pivot assembly comprises:
a base;
a shaft rotatably coupled to the base;
a pivoting member coupled to the shaft; and
at least one arm extend from the pivoting member and engaging the plate.

18. A turbine assembly actuated for providing rotational energy to a coupled generator to generate electricity, comprising:
a pivot structure comprising a substructure disposed in an excavation under a road configured to support a transverse rotating shaft perpendicular to the axis of the axis of the road, affixed to the substructure;
a load-bearing pivoting treadle plate pivotably mounted upon the transverse rotating shaft that comprises a pivot for the pivoting treadle plate to pivot it from a first position angled upwards relative to the surface of the road for automobiles to drive upon to a second horizontal position substantially level and flush with the surrounding road;
a counterweight mounted upon the pivoting treadle plate on the approach side of the pivot, wherein the counterweight is actuated to move downward by the pulling force of gravity to pivot the pivoting treadle plate upward relative to the surface of the road in a first position and wherein the kinetic energy of the automobiles driving upon the pivoting treadle plate depress the pivoting treadle plate to a second position level and flush with the roadway and also raises the counterweight to an upward position disposed in the excavation beneath the roadway, and wherein when the automobile passes beyond the pivoting treadle plate back onto the roadway, gravity again pulls down the counterweight to actuate the movement of the pivoting treadle plate to its angled first position;
a rigid downshaft fixedly, tiltably or movably mounted on and supported by the underside of the pivoting treadle plate surface movable by the movement of the pivoting treadle plate between its first position and second position, wherein when the pivoting treadle plate is depressed by the speed and weight of automobiles from its raised first position to its lowered horizontal second position, the downshaft is driven downward;
a Pitman arm coupled to and supported by the lower end of the downshaft, wherein the Pitman arm is part of the driving system that engages a crank of a rotating structure to move the crank in a rotational motion to convert linear motion into rotational motion;
at least one horizontal rotating shaft supported by one or more substructures to permit rotation from engagement of the crank rotating the at least one horizontal rotating shaft;
at least one flywheel rotatably mounted on and supported by the at least one horizontal rotating shaft to rotate to store energy, wherein the rotation of the crank rotates the shaft to rotate the flywheels;
at least two adjacent rotating shafts comprising a driven rotating shaft and a driving rotating shaft, the driven rotating shaft and the driving rotating shaft have interposed between them a one-way and disengageable ratchet mechanism that enables the driven rotating shaft to rotate independently and faster than the driving rotating shaft, wherein the ratchet mechanism may be interposed between the crank and a first flywheel or between the driving rotational shaft on which is mounted the first flywheel and the driven rotational shaft on which is mounted a second flywheel to make the driven second flywheel into a freewheel second flywheel to continue providing speed and torque faster than the driving shaft and also keep rotating when the driving shaft is stopped to drive the rotation of a shaft to spin the generator; and
an output shaft from the freewheel second flywheel that is most proximate to the generator to engage the generator to rotate the interface to spin the generator to generate electricity.

19. The turbine assembly of claim 18, wherein a gearbox is interposed between the last flywheel and the generator.

20. A method of generating electricity with a vehicle-actuated treadle system, comprising:
driving over a plate in the road to pivot the plate from a first position to a second position;
exerting a downward motion from the plate to a drive shaft of a turbine assembly of the vehicle-actuated treadle system;
converting the downward motion of the drive shaft to rotation of at least one flywheel;
spinning a generator with the rotation of the at least one flywheel; and
generating electricity from the spinning generator.

21. The method of claim 18, wherein plate pivots from the first position to the second position when a vehicle overcomes a counterweight of the plate to pivot the plate to the second position.

22. The method of claim 19, wherein the plate is angled relative to a top surface of a surrounding roadway in the first position and wherein the plate is flush with the top surface of the surrounding roadway in the second position.

23. A gravity-actuated and vehicle-actuated treadle system for generating electric power, comprising:
a plate including a counterweight coupled to a first end of the plate;
a hinge member coupled to a first end of the plate and a first road piece; and
at least one turbine assembly coupled to and extending from the bottom surface of the plate.
